(19) United States
(12) Patent Application Publication
(10) Pub. No.: US 2009/0044496 A1
(43) Pub. Date: Feb. 19, 2009

(54) Method and apparatus for sealing a glass package

(76) Inventors: John W. Botelho, Corning, NY (US); Margaret Helen Gentile, Painted Post, NY (US); Kenneth Spencer Morgan, Painted Post, NY (US); William Robert Powell, Horseheads, NY (US); Lu Zhang, Painted Post, NY (US)

Correspondence Address: CORNING INCORPORATED, SP-TI-3-1, CORNING, NY, 14831, US

(21) Appl. No.: 11/893,574

(22) Filed: Aug. 16, 2007

(51) Int. Cl. B65B 51/10; C03B 29/00

(52) U.S. Cl. 53/477; 65/270; 313/512; 29/729; 29/739; 29/855

(57) ABSTRACT

An apparatus for sealing a glass package by applying a force to a glass assembly while simultaneously irradiating a sealing material disposed between the two glass substrates with a beam of radiation. The applied force is translated in unison with the radiation beam. The radiation cures and/or melts the sealing material, depending upon the sealing material. The applied force beneficially improves contact between the glass substrates and the sealing material during the sealing process, therefore assisting in achieving a hermetic seal between the substrates.

### BACKGROUND OF THE INVENTION

1. Field of the Invention

This invention relates to a method and an apparatus for sealing a glass package, and in particular sealing an organic light emitting diode display device with radiation.

2. Technical Background

Flat panel display devices, such as liquid crystal and plasma display devices for use in televisions, continue to replace cathode ray tube display devices as the display of choice for a broad array of applications, from cell phones to televisions.

More recently, organic light emitting diode (OLED) display devices have made progress in the market place. Unlike LCD displays, which utilize a liquid crystal layer to alternately pass and block a light source, and plasma displays which emit light from a charged gas, OLED displays utilize an essentially solid state array of organic light emitting diode devices to generate light, each organic light emitting diode comprising one or more layers of an organic material sandwiched between electrodes, typically an anode and a cathode, as well as ancillary electronic circuitry to control the emission state of the diode.

OLED display devices advantageously comprise a thin form factor, low power consumption, a wide color gamut, a high contrast ratio fast response time and a lower temperature manufacturing process compared to, for example, LCD display technologies.

In spite of the foregoing advantages, the one or more organic layers comprising each OLED is susceptible to degradation in the presence of oxygen and/or moisture. Therefore, great effort is made to provide a hermetic package to contain the OLED devices.

Prior art displays have used adhesive-based seals, typically between thin glass substrates. However, adhesives, such as various epoxies, tend to have unacceptable leakage rates for long device life, thereby requiring a desiccant to be disposed within the sealed glass package to absorb moisture and/or various gases which may penetrate the seal, or which may be generated during curing of the adhesive seal.

More recently, frit sealing of the glass package has become a practical alternative. In frit sealing, a glass frit is deposited between the two glass substrates. The glass frit is heated to soften or melt the frit, thereby forming a hermetic seal between the substrates. Because the organic material comprising the OLED will degrade at temperatures much over 100° C., the heating must be localized, and is typically done using a laser or by masking a broad heat source, such as an infrared lamp.

To ensure a good frit seal, such factors as the expansion compatibility of the frit and the substrates, the speed of the laser, the laser power, and the absorption characteristics of the frit and substrates should be considered. A further consideration is the quality of the contact between the frit and the substrates during the sealing process, which can be impacted by the amount of force applied to one or both of the substrates during the sealing process. In the simplest process, the weight of the top substrate applies a given force against the sealing material. However, the weight of the substrate in and of itself is insufficient for facilitating a good seal. Simply placing the aligned sheets of glass beneath the laser and sealing with the laser will produce a seal, but one that has narrow patches as well as delamination defects, which are both caused by irregularities in the dispensed sealing material (e.g. frit). These artifacts of the sealing process have a severely detrimental effect on the life and performance of an OLED device disposed between the substrates. Applying force during the sealing process minimizes these defects, as well as increases the overall seal width. Consequently, alternative methods for applying a force to the top substrate are needed.

The method/apparatus for applying a sealing force should be inexpensive, and should also be low-precision, as time-consuming alignment operations cost money. It should utilize simple technology that any operator can learn with minimal training. It should not be resource heavy. That is, any consumables it requires should be kept to a minimum or be reusable by the system. It should have high repeatability for quality seals as determined by visual inspection of the seal itself and also of device life. It should also not damage the glass or OLED material in any way. These and other needs are addressed by the present invention disclosed hereinafter.

### SUMMARY

An apparatus and method are disclosed that can improve the seal quality of a glass package, and in particular a glass package comprising one or more organic light emitting diode devices. In one broad aspect the present invention is used to apply a force against an assembly comprising first and second glass substrates, and including a sealing material disposed therebetween. Simultaneous with the application of the force, a beam of radiation is used to irradiate the sealing material, thereby connecting the first substrate to the second substrate according to the nature of the sealing material. For example, if the sealing material is an adhesive, such as an epoxy adhesive, the radiation beam may cure the adhesive. If the sealing material is a glass-based frit, the radiation beam can be used to heat and soften the frit to form the seal. Both the laser beam and the applied force are traversed over the length of the sealing material to form a sealed glass package. Preferably, the glass package is hermetically sealed such that oxygen and/or water do not penetrate the seal at more than about 10⁻³ cc/m²/day and/or 10⁻⁶ g/m²/day, respectively. Thus, the life of an organic light emitting diode (OLED) device that may be disposed between the first and second substrates and encircled by the sealing material may advantageously be extended.

The force is applied by bearing elements that contact and press against the glass assembly. The bearing elements are biased by a restoring force, such as a spring or gas pressure, so that once contact with the assembly is made (e.g. one of the glass substrates), further movement of the apparatus toward the assembly applies a force against the assembly. The bearing elements may be adapted to roll across the surface of a substrate or to slide across the surface of the substrate. Preferably, the force is applied against the assembly in proximity to the point on the assembly at which the radiation beam impinges. That is, it is preferably that a plurality of bearing elements generally encircle the point at which the beam impinges so that the force is relatively uniformly applied to the substrate(s) and transmitted to the sealing material. Thus, contact between the sealing material and the substrates can be improved by causing the sealing material to spread against the substrates. Moreover, the force applied by the method and apparatus disclosed herein can mitigate against unevenness in the height of the sealing material above the substrate on which the sealing material may be dispensed. This unevenness can result in a poor seal between the substrates.

In some embodiments, the radiation source is slidably connected to a housing, such as through a collet, the position of the housing thus being adjustable relative to the radiation source. In some embodiments, the position of the radiation source may be fixed, and the beam of radiation directed by optical elements, such as mirrors, attached to the housing so that the beam traverses the assembly without the need for moving the radiation source.

In accordance with an embodiment of the present invention, a method for sealing a glass package is disclosed comprising providing an assembly comprising first and second glass substrates and a sealing material disposed between the first and second substrates, contacting the assembly with at least one bearing element to exert a force against the first or second substrate, irradiating the sealing material with a radiation source; and translating the bearing element and the radiation source during the irradiating, thereby forming a hermetic seal between the first and second substrates

In another embodiment, a method for sealing a glass package is described comprising providing an assembly comprising first and second glass substrates and a frit disposed between the first and second substrates, contacting the assembly with a plurality of bearing elements to exert a force against the assembly, irradiating the frit with a laser beam to heat and soften the frit and translating the plurality of bearing elements relative to the frit and in unison with the laser beam, thereby forming a hermetic seal between the first and second substrates

In still another embodiment, an apparatus for sealing a glass assembly is disclosed comprising a housing defining at least one bore, a bearing element disposed within the at least one bore and moveable relative to the bore for applying a force to an assembly comprising glass substrates and a sealing material, means for applying a restoring force to the bearing element, means for translating the housing relative to the assembly and a radiation source adapted to emit a beam of radiation that moves in unison with the housing to irradiate the sealing material.

It is to be understood that both the foregoing general description and the following detailed description present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate an exemplary embodiment of the invention and, together with the description, serve to explain the principles and operations of the invention.

### BRIEF DESCRIPTION OF THE DRAWINGS

FIG. 1A is an exploded view of an apparatus for sealing a glass package (e.g. substrate assembly) according to an embodiment of the present invention.

FIG. 1B is a perspective view of the apparatus of FIG. 1A.

FIG. 1C is a side view of the apparatus of FIG. 1A.

FIG. 2 is a cross sectional side view of an exemplary substrate assembly comprising an organic light emitting diode (OLED) device.

FIG. 3A is a top view of a housing comprising the apparatus of FIG. 1.

FIG. 3B is a cross sectional view of the housing of FIG. 3A.

FIG. 3C is a close up view of a portion of the housing of FIG. 3B depicting a portion of a bore.

FIG. 4 is a longitudinal cross sectional view of a pushrod in accordance with an embodiment of the present invention

FIG. 5 is a cross sectional view of a bearing holder in accordance with an embodiment of the present invention

FIG. 6 is a perspective view of the bearing block in accordance with an embodiment of the present invention.

FIG. 7A is a perspective view of the collet for holding the radiation source

FIG. 7B is an end view of the collet of FIG. 7A.

FIG. 7C is a cross sectional longitudinal view of the collet of FIG. 7A.

FIG. 7D is another side view of the collet of FIG. 7A showing the mounting holes for attaching the collet to a support.

FIG. 8 is a perspective view of an adjustment screw in accordance with an embodiment of the present invention.

FIG. 9 is a top view of a substrate assembly showing a plurality of display devices deposed therein.

FIG. 10 is a perspective view of the apparatus of FIG. 1 mounted to a positioning system.

FIG. 11 is a perspective view of an embodiment of an alternative housing for use in the apparatus of FIG. 1.

FIG. 12 is a top view of the housing of FIG. 11.

FIG. 13 is a cross sectional view of the housing of FIG. 11.

FIG. 14 is a close up cross sectional view of the housing of FIG. 11 showing a bearing disposed within a gas passage.

FIG. 15 is a perspective view of an apparatus for sealing a glass package (e.g. substrate assembly) according to an embodiment of the present invention using the housing of FIG. 11, showing the bottom of the apparatus, the plurality of gas passages, each of the gas passages containing a bearing element.

### DETAILED DESCRIPTION

In the following detailed description, for purposes of explanation and not limitation, example embodiments disclosing specific details are set forth to provide a thorough understanding of the present invention. However, it will be apparent to one having ordinary skill in the art, having had the benefit of the present disclosure, that the present invention may be practiced in other embodiments that depart from the specific details disclosed herein. Moreover, descriptions of well-known devices, methods and materials may be omitted so as not to obscure the description of the present invention. Finally, wherever applicable, like reference numerals refer to like elements.

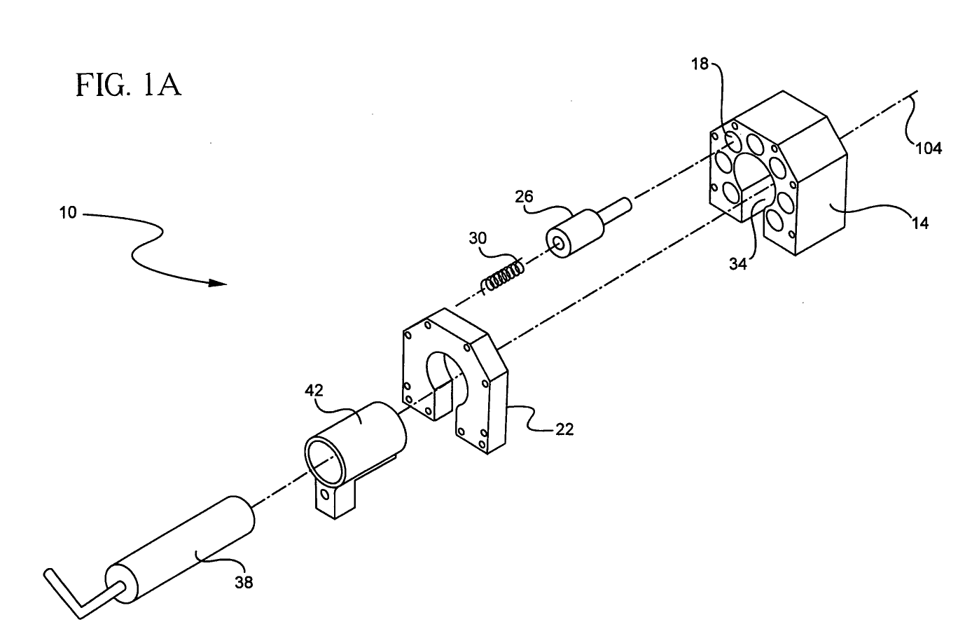

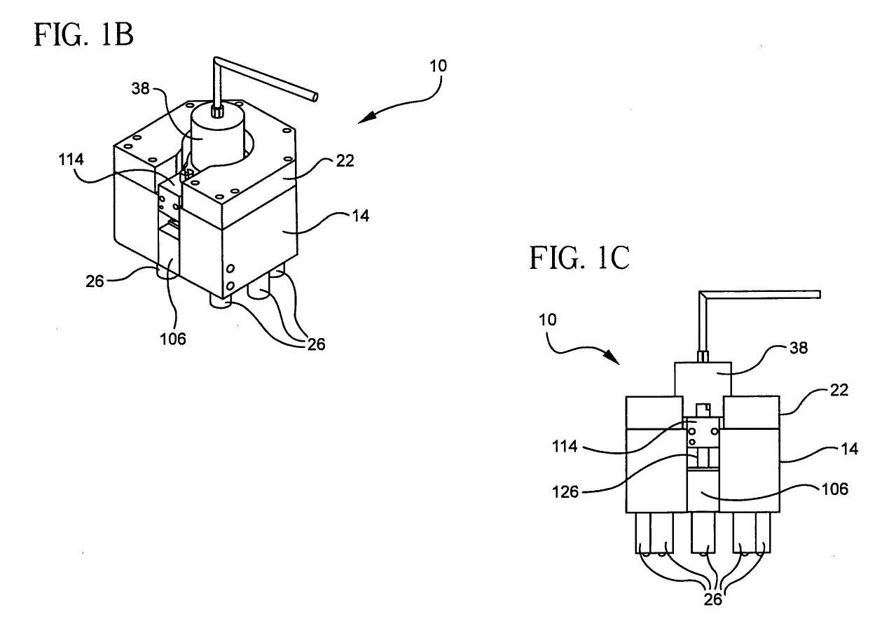

Shown in FIGS. 1A-1C is an embodiment of an apparatus 10, shown in an exploded perspective view in FIG. 1A, for sealing substrate assemblies by applying a predetermined force on the substrate assembly while simultaneously exposing the substrate assembly to a beam of radiation that seals the substrate assembly. The application of a predetermined force is beneficial in facilitating an appropriate seal, and is particularly useful for forming a hermetic seal in a display assembly. Preferably, the force is applied proximate the point at which the radiation beam irradiates the substrate assembly, and is capable of moving with the beam as the beam traverses the assembly. FIG. 1B shows a perspective view of apparatus 10, while FIG. 1C depicts a side view of apparatus 10.

Referring now to FIG. 1A, apparatus 10 comprises housing 14 defining at least one bore 18 extending through the housing, cover plate 22, bearing assembly 26 disposed within the at least one bore for contacting a surface of the substrate assembly and applying a force thereto, and spring 30 for applying a restoring force to bearing assembly 26. The force applied by spring 30 is transferred to the contacted surface of the substrate assembly by bearing assembly 26.

Housing 14 further defines a passage or channel 34 that provides a pathway for a beam of radiation emitted by radiation source 38, thereby allowing the beam of radiation to pass unobstructed through housing 14. Apparatus 10 further comprises collet 42 for mounting radiation source 38, collet 42 being adapted to fit and be translatable (e.g. slidable) within passage 34.

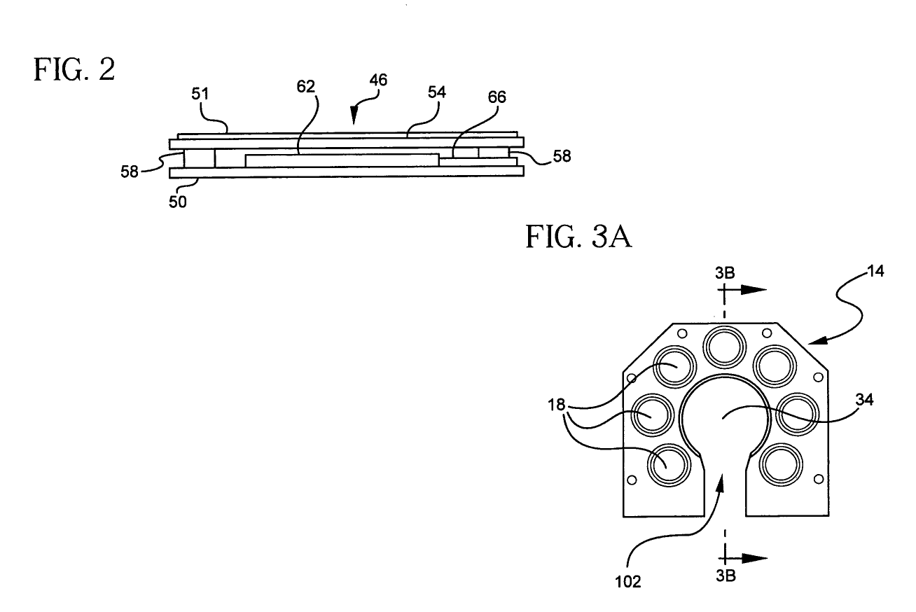

Substrate assembly 46, best shown in FIG. 2, comprises first substrate 50, second substrate 54, and a sealing material 58 disposed between the first and second substrates. Preferably, the first and second substrates are glass substrates, such as substrates suitable for use in the manufacture of flat panel display devices (e.g. organic light emitting diode display devices). Such glass substrates are thin, having a thickness typically less than about 1 mm, and in some embodiments a thickness less than about 0.7 mm. Exemplary glass substrates are those manufactured and sold by Corning Incorporated as code 1737, 1737F, Eagle2000™ or Eagle XG™. Substrate assembly 46 may also include one or more organic light emitting diode (OLED) devices 62, as well as associated electrical and/or electronic components, such as one or more electrodes 66 connected with OLED device 62.

Although sealing material 58 may be any sealing material suitable for sealing flat panel display substrates, such as, for example, a radiation-curable adhesive (e.g. epoxy), sealing material 58 is preferably a glass-based frit. The frit may be applied as a powder or a paste, but is more often applied as a paste formed from glass powders mixed with organic binders and a solvent or carrier. To ensure sealing material (e.g. frit) 58 is capable of forming a robust hermetic seal with the substrates, the coefficient of thermal expansion (CTE) of the sealing material should substantially match the CTEs of the first and second substrates. The frit may also include an inert filler material for raising, but more often lowering, a coefficient of thermal expansion (CTE) of the frit. Suitable inert fillers include beta eucryptite. Preferably, a thermal expansion mismatch between substrates 50, 54 and sealing material 58 is less than about 350 ppm at 125° C.

Because sealing material 58 is sealed by irradiating the sealing material with a beam of radiation, and typically through one or both of first or second substrates 50, 54, sealing material 58 should substantially absorb radiation at a wavelength emitted by radiation source 38, such that the absorbed radiation is converted to heat that cures, softens or melts the sealing material (depending upon the sealing material), thereby forming a hermetic seal extending between the first and second substrates. For example, if sealing material 58 is a glass frit, absorption of the frit may be enhanced by doping the frit with a transition metal. Suitable transition metals include, for example, iron, neodymium, vanadium and copper. Preferably, the first and second substrates do not absorb an appreciable amount of radiation at the wavelength or range of wavelengths emitted by radiation source 38, typically in a wavelength range between about 800 nm and 1500 nm. Thus, the first and second substrates are preferably transparent or substantially transparent at the wavelength or range of wavelengths emitted by the radiation source. In this way, the frit can be irradiated through the first or second substrate without substantial heating of the substrates: The frit absorbs a substantial portion of the radiation, and is thereby heated to at least a softening point of the frit, thereby forming a hermetic seal between the first and second substrates. The frit preferably absorbs at least about 65% of the radiation incident on the frit. The hermetic seal should provide a barrier for oxygen (10⁻³ cc/m²/day) and water (10⁻⁶ g/m²/day). That is, water and/or oxygen should not penetrate the seal at more than the preceding rates.

Radiation source 38 may be any radiation source suitable for irradiating sealing material 58 and forming a hermetic seal between the first and second substrates, such as an infrared lamp for example. However, radiation source 38 is typically a laser. The choice of laser and the emission wavelength or range of wavelengths is selected to correspond with a high absorption band of the sealing material. For instances where sealing material 58 is a glass frit, choices of lasers may include Ytterbium (900 nm<λ<1200 nm), Nd:YAG (λ=1064 μm), Nd:YALO (λ=1.08 elm), erbium (λ≈1.5 μm) and CO₂ lasers. The appropriate laser is selected based on the frit composition and the absorption band of the frit. Other radiation sources such as microwave sources or masers are also contemplated, depending upon the specific sealing material. That is to say, the emitting source should be compatible with the sealing material and the article or articles to be sealed.

Substrate assembly 46 may further include optional mask 51 disposed over one or both of substrates 50 and/or 54. Mask 51 may be, for example, a glass plate having a masking material disposed on the plate so that much of the surface of the glass plate is opaque to the sealing radiation, with the exception of transparent pathways corresponding to the sealing material pattern disposed between substrates 50, 54. Thus, the sensitive OLED material disposed between substrates 50, 54 can be protected from the beam of radiation.

To ensure an adequate hermetic seal between substrates 50, 54, apparatus 10 may be used to apply a suitable local force to top substrate 54 proximate the area irradiated by radiation source 38, and thereby assure good contact between the substrates and the sealing material.

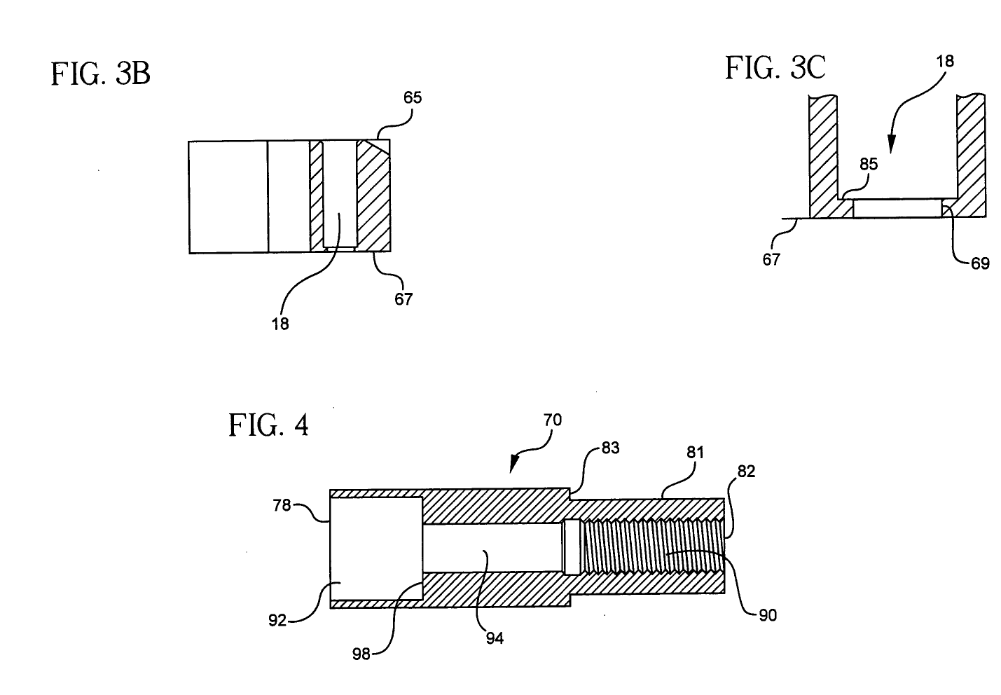

As best shown in FIGS. 3A-3C housing 14 of apparatus 10 preferably defines a plurality of bores 18 extending between a top surface 65 and a bottom surface 67 of the housing. The plurality of bores 18 may, for example, be disposed concentrically about passage 34. Each bore 18 includes a narrowed portion 69 at an end thereof for retaining bearing assembly 26 within the bore and preventing the bearing assembly from passing completely through the bore.

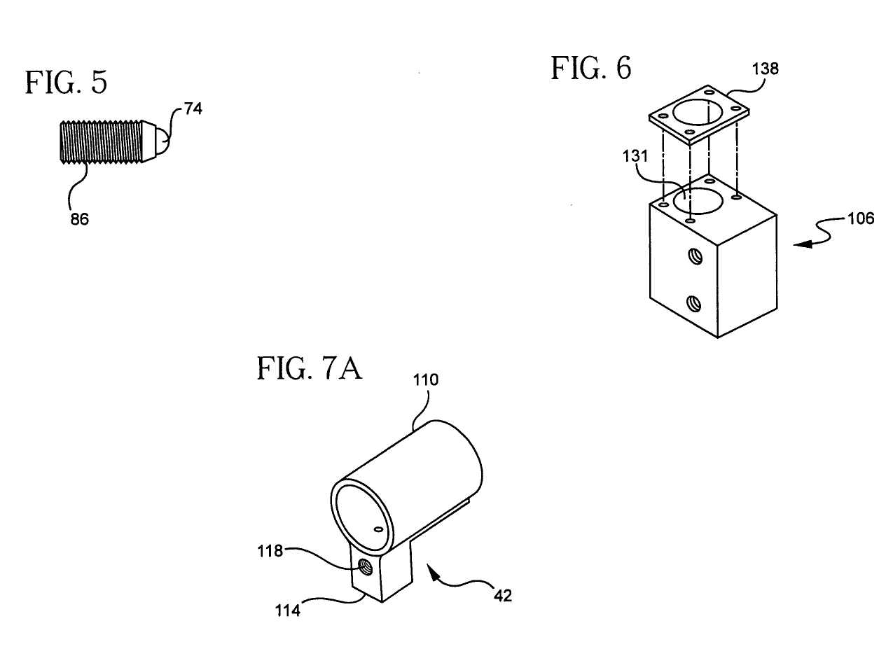

Referring now to FIGS. 4-5, each bearing assembly 26 comprises a push rod 70 (FIG. 4) and a bearing element 74 (FIG. 5). For the purpose of description, each push rod 70 comprises a proximal end 78 and a distal end 82, the proximal end 78 being disposed within bore 18 and farthest from substrate assembly 46 during operation of apparatus 10. Push rod 70 also includes a narrowed barrel portion 81 sized to fit through narrowed portion 69 of bore 18, wherein shoulder 83 of pushrod 70 abuts lip 85 of bore 18. Spring 30 (FIG. 1) then biases pushrod 70 against lip 85 with a predetermined force.

Bearing element 74 may be disposed directly in distal end 82 of push rod 70, or as illustrated in FIG. 5, bearing element 74 is first disposed in bearing holder 86 and bearing holder 86 then connected to distal end 82 of push rod 70. Preferably distal end 82 of push rod 70 extends from housing 14. In the embodiment of FIG. 5, bearing element 74 is a ball bearing that is retained in a rolling relationship with bearing holder 86. That is, bearing element 74 is free to roll or rotate within bearing holder 86. However, it should be noted that other bearing forms may be used as alternatives. For example, bearing element 74 could be a fixed element formed from a material softer than the substrate(s) of substrate assembly 46 and having a low coefficient of friction, wherein during contact with and translation across a surface of the substrate assembly, the contacted substrate is not damaged. Bearing holder 86 is connected to push rod 70 by any suitable means. However, preferably the connecting means is capable of adjustment such that the distance bearing element 74 extends away from housing 14 can be adjusted. For example, bearing holder 86 may be connected to push rod 70 by screw threads, with complimentary screw threads being incorporated within a receiving bore 90 of push rod 70.

Push rod 70 is preferably translatable within bore 18. That is, push rod 70 is slidable within housing bore 18. To ensure that an adequate sealing force is applied to substrate assembly 46, a preload force is applied to bearing assembly 26 to ensure that bearing element 74 applies a minimum amount of force to substrate assembly 46. This can be understood in the following way. If apparatus 10 is allowed to freely rest on substrate assembly 46, the force that will be applied to substrate assembly 46 is the weight of apparatus 10. However, the weight of apparatus 10 may by itself be insufficient to apply an appropriate sealing force to substrate assembly 46. Thus, apparatus 10 is preferably rigidly mounted to a suitable device for translating apparatus 10 parallel to a surface of the substrate assembly. Apparatus 10 is also brought into contact with a surface of substrate assembly 46 such that pushrod 70 is unseated and spring 30 is compressed. In other words, the pushrods are preloaded or biased. By biasing the pushrods, and thus the bearing holder and bearing, a minimum predetermined force that is greater than the weight of assembly 10 can be applied to the substrate assembly by positioning apparatus 10 a predetermined distance from the substrate assembly. This compresses spring(s) 30. Accordingly, a restoring force is applied against bearing assembly 26 by spring 30 in contact with bearing assembly 26. The amount of restoring force is a function of the spring constant of spring 30, and the amount of compression spring 30 undergoes.

Preferably, spring 30 is a coil spring that is sized to fit within bore 18. For example, spring 30 may be in direct contact with proximal end 78 of push rod 70, or, as shown in FIG. 4, push rod 70 may include an enlarged bore or recess 92 for receiving an end of spring 30, spring 30 then resting on shoulder 98. The opposite end of spring 30 is retained within bore 18 by retaining plate 22 attached to housing 14. Bearing holder 86 may, for example, be adapted to be turned with a suitable tool through passage 94. For example, bearing holder 86 may be adapted such that bearing holder 86 can be turned with a screwdriver.

Of course other methods of applying a preload force against bearing assembly 26 may be used. For example, each bore 18 may be supplied with a pressurized gas from a suitable source (not shown) above bearing assembly 26 thereby forcing each bearing assembly 26 downward. Pushrod 70 may include a gasket (e.g. o-ring) to form an appropriate seal between the pushrod and an internal wall of bore 18. Alternatively, pushrod 70 may be sized such that pushrod 70 forms an acceptable seal without the need for a gasket. The pressurized gas thus replaces spring(s) 30.

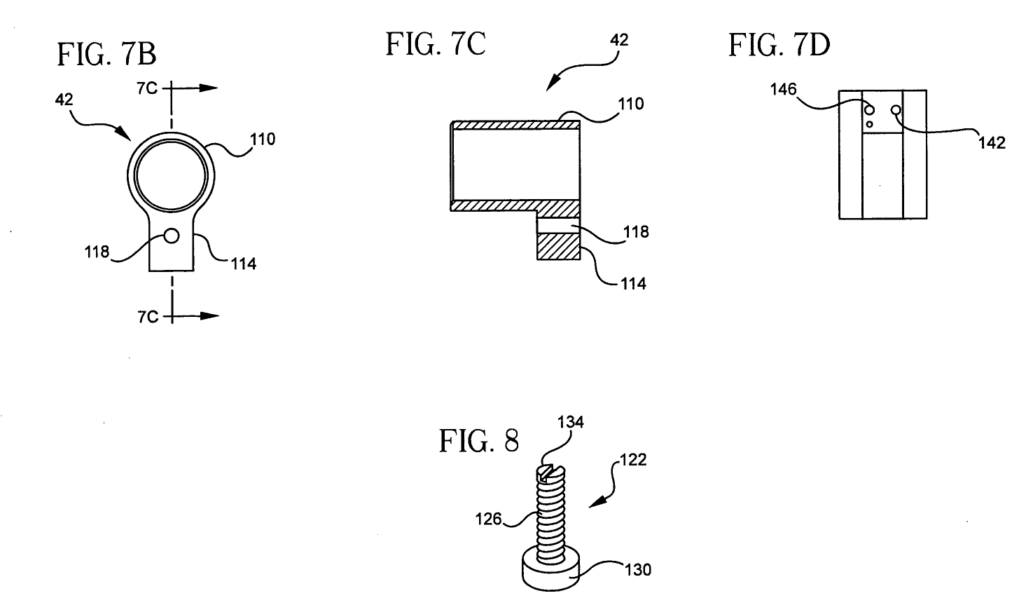

Radiation source 38 is mounted to collet 42, and collet 42 is movable within housing 14. In accordance with the embodiment illustrated in FIG. 3A, housing 14 further includes slot 102 extending from an outside surface of housing 14 to passage 34 and into which slot and/or passage are disposed bearing block 106 (FIG. 6) and collet 42. As depicted in FIG. 7A-7C, collet 42 comprises an annular sleeve portion 110 and a block or tab portion 114. Sleeve portion 110 fits within passage 34 while tab portion 114 fits within slot 102. Thus, when collet 42 is fixed (i.e. mounted to a suitable mount, such as a device for translating apparatus 10 over substrate assembly 46), housing 14 is translatable relative to collet 42. That is, housing 14 may be raised or lowered relative to collet 42, thus providing an adjustment by which housing 14 may be raised or lowered relative to substrate assembly 46. In this manner, the force applied against substrate 46 can be adjusted according to the position of housing 14 (e.g. via the spring constant of spring(s) 30). An exemplary manner in which that adjustment may be made is described next.

Tab portion 114 of collet 42 defines a threaded bore 118 in which is disposed adjustment screw 122 (FIG. 8). Adjustment screw 122 comprises threaded shaft 126, and enlarged end 130. During certain operations enlarged end 130 bears against bearing block 106, and in particular enlarged end 130 is disposed within recess 131, and retained within recess 131, by retaining plate 138. The opposite end 134 of adjustment screw 122 comprises an adjustment means. For example, the adjustment means may be adapted for adjustment with a screwdriver, as shown in FIG. 8, with a hex or bolt head for a wrench, or any other suitable means of turning adjustment screw 122. Adjustment crew 122 may, for example, be connected to a motor (e.g. a stepper motor—not shown) for motorized control. The motor may be advantageously controlled through appropriate control circuitry (e.g. a computer and suitable relays) to provide automated or semi-automated control of the motor.

When adjustment screw 122 is turned, tab portion 114 translates relative to adjustment screw 122, and, depending on the direction of rotation of adjustment screw 122, housing 14 is translated relative to collet 42. For example, if adjustment screw 122 is turned in a direction which increases the extension of adjustment screw 122 between tab portion 114 and bearing block 106, the enlarged end 130 of adjustment screw 122 bearing on bearing block 106 causes housing 14 to translate relative to collet 42 and to thereby lower housing 14 (and bearing elements 74) relative to substrate assembly 46 (i.e. second substrate 54). Conversely, if adjustment screw 122 is turned in a direction which decreases the extension of adjustment screw 122 between tab portion 114 and bearing block 106, the upper surface of enlarged end 130 of adjustment screw 122 contacts retaining plate 138 mounted on bearing block 106, thereby causing housing 14 to translate relative to collet 42 and to raise housing 14 (and bearing elements 74) relative to substrate assembly 46 (i.e. second substrate 54).

Sleeve portion 110 of collet 42 is adapted for mounting radiation source 38. For example, radiation source 38 may be a laser mounted in a cylindrical housing that is press-fit into sleeve portion 110.

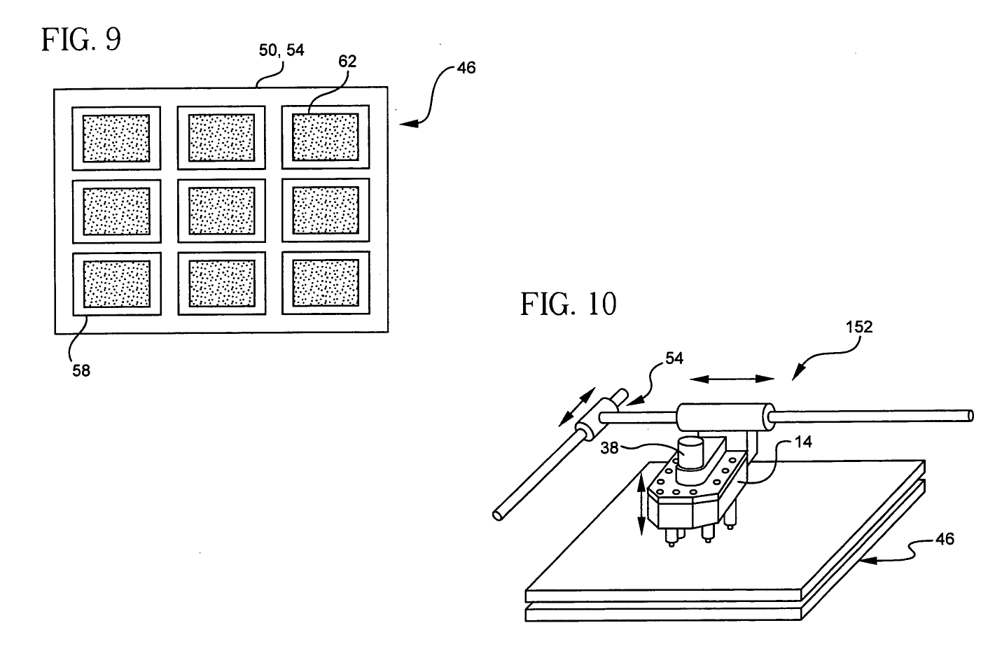

Collet 42 also defines threaded passages 142 and 146 by which mounting bolts may be used to mount collet 42 to a suitable device for translating housing 14 over substrate assembly 46, and in particular second substrate 54. For example, in a typical process for forming OLED display devices, sealing material 58 is dispensed onto second substrate 54 in a pattern to circumscribe the one or more OLED devices 62 that are deposited on first substrate 50. The circumscribing pattern of the sealing material is most usually in the shape of a rectangular perimeter or picture frame that encircles the OLED device. Often, as illustrated in FIG. 9, there are multiple OLED display devices being formed between two large substrates joined by sealing material. These multiple display devices are typically laid out in an array of rows and columns on the first substrate, with corresponding frit walls or frames similarly arrayed on the second substrate. The process of sealing multiple OLED display devices disposed between several large substrates increases productivity by increasing the number of display devices that can be formed from two given master or parent substrates. The frit walls or frames may be formed on one substrate, while the corresponding OLED devices are formed on the other substrate, or both the sealant material and the OLED devices may be formed on the same substrate. In any event, the first and second substrates are brought together such that an OLED device 62 is circumscribed by each sealant frame.

In one embodiment, best shown in FIG. 10, housing 14, including radiation source 38, is mounted on an XY positioning system 152 (including rail or gantry system 154, linear motors/actuators, translation stages, position sensors and so forth) over substrate assembly 46 such that housing 14 and radiation source 38 may be moved to any location over substrate assembly 46. Such positioning systems are well known in the art and will not be described further. Preferably, positioning system 152 includes a computer control such that housing 14, and thus radiation source 38, may be automatically positioned and translated with respect to substrate assembly 46 according to pre-programmed instructions. Thus, radiation source 38 (and the radiation beam emitted from radiation source 38) may be translated over and around each sealing material pattern to form a seal between the first and second substrates. Once the substrates have been sealed, the individual OLED displays are separated from the substrate assembly, and thereafter used in the manufacturing of a particular device (e.g. cell phone, camera, etc.).

As housing 14 is translated over substrate assembly 46, bearing elements 74 contact the upper surface of second substrate 54, thus applying a downward pressure or force against second substrate 54. For sealing OLED displays, the force should be less than about 5 pounds (2.27 kg), preferably less than about 3 pounds (1.36 kg) for each bearing element. In some embodiments, the force applied per bearing element should be between about 0.6 pounds (0.27 kg) and 0.7 pounds (0.32 kg). However, the optimal force is dependent, inter alia, on the width of a particular line or wall of sealant and the size of individual display devices disposed on the substrates.

In one embodiment, a plurality of OLED devices are deposited onto the first substrate, along with other associated electrical or electronic elements, such as electrodes for facilitating an electrical connection to the OLED devices. This may be accomplished at the manufacturer of the OLED displays. A plurality of frit walls may be deposited on the second substrate. This may be done, for example, by the substrate manufacturer, or by the maker of the OLED displays. The frit may be deposited onto the second substrate as a paste, after which the frit substrate assembly is heated to drive off the binder and solvent, and pre-sinter the frit to form a “fritted” cover substrate. The fritted cover substrate may then be placed overtop the first substrate having the OLED device disposed thereon, with the frit positioned between the first and second substrates such that the frit forms a frame or barrier (not unlike a picture frame) around each OLED device. System 152 (including apparatus 10) may then be used to heat the frit so that the frit softens or melts, thereby forming a hermetic seal between the first and second substrates, and about each OLED device.

### EXPERIMENT 1

To illustrate the sealing process, an experiment was conducted using a substrate assembly 46 comprising first and second glass substrates. Each of the first and second substrates was approximately 0.7 mm in thickness. The first substrate did not include OLED devices. The second substrate included nine frit walls formed in the shape of rectangular walls or frames that had been deposited onto the second substrate and pre-sintered. The width of the frit wall was approximately 2 mm at the surface of the second substrate. The second substrate was placed overtop the first substrate with the pre-sintered frit disposed between the two substrates. Apparatus 10 was thereafter used to seal each of the nine frit walls with a predetermined force per ball bearing. The laser power was 23 watts at a nominal wavelength of about 900 nm. The laser (i.e. apparatus 10) was traversed over each frit wall. The experiment was repeated for 9 substrate assemblies: The results are shown in Table 1 for 6 randomly chosen points among the formed seals. Trials (A-C) were conducted by applying a force per bearing as indicated in Table 1. The data are presented as the seal width ratio: the seal width in microns divided by the overall width of the frit in the same spot in microns) at the surface of first substrate 50—generally, the wider the seal, the better the sealing process.

TABLE 1

| | A | B | C |
|---|---|---|---|
| | 0.5 lbs. | 0.75 lbs | 1 lb. |
| 1 | 0.708874 | 0.716454 | 0.597205 |
| 2 | 0.668089 | 0.735978 | 0.711069 |
| 3 | 0.679139 | 0.703884 | 0.705757 |
| 4 | 0.715486 | 0.71855 | 0.648779 |
| 5 | 0.704223 | 0.71886 | 0.66069 |
| 6 | 0.689871 | 0.711498 | 0.704351 |

The data in table 1 show that as the sealing force per bearing increased, the seal width ratio increased. However, once a peak is reached, at about 0.75 lbs in this experiment, the seal width, and the presumed quality of the seal, decreased.

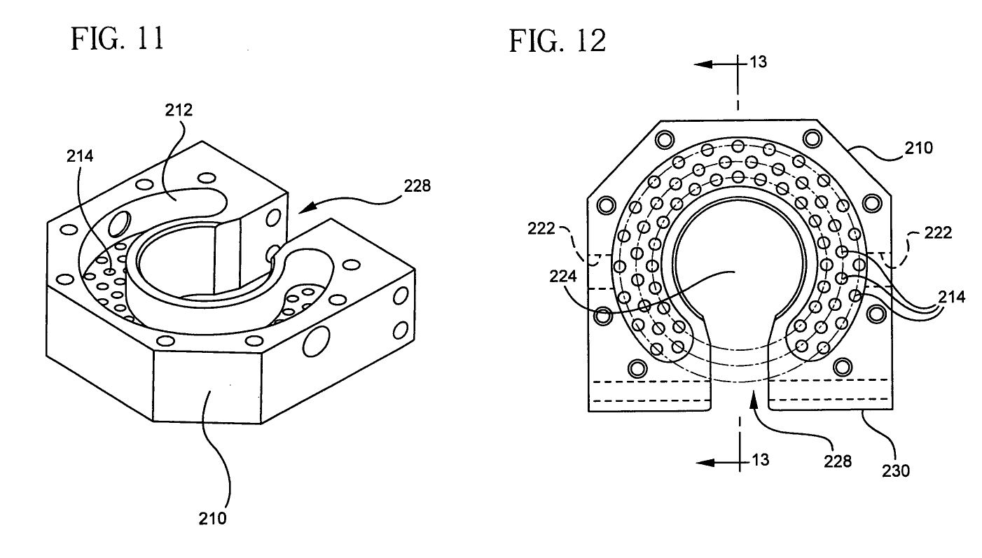

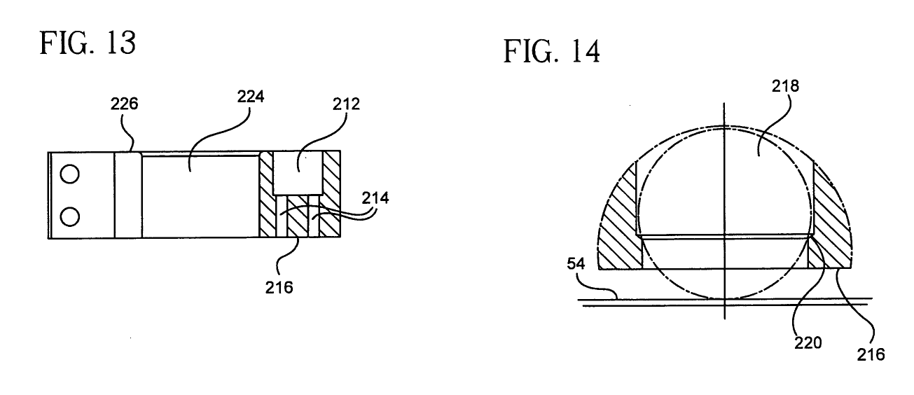

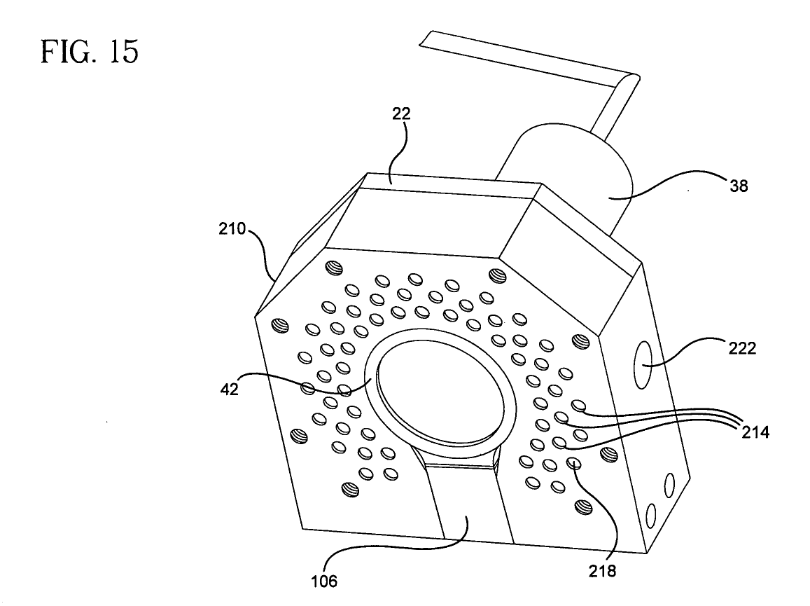

In another embodiment of the present invention housing 210 shown in FIGS. 11-13 is substituted for housing 14 in apparatus 10. Housing 210 comprises plenum 212 for distributing a pressurized gas within the housing, and further defines a plurality of channels or passages 214 extending from plenum 212 to an outside bottom surface 216 of housing 210. Point loads on the fragile display glass can cause excessive stresses and damage. The amount of stress for a point load, represented by a plastic ball on a plate is

$$1.2 \times {10}^{8} \frac{N}{{M}^{2}}$$

for a load of just 1 lb. Cracking has been observed for loads as little as 5 lbs. However, small forces in the range of 0.25-0.75 lbs appeared to produce a seal that is on par with conventional methods when delivered as a rolling point load contact. The present embodiment combines these two loading strategies into one device, utilizing many densely packed point loads, each applying a very small force. All together, these point loads mimic a more distributed force, which is easier on the glass in terms of reduced stress.

Each passage 214 of the plurality of passages contains a bearing element (e.g. ball bearing) 218 sized to fit within each passage 214. Each passage 214 also comprises a narrowed portion 220 (FIG. 14) located at the end of each passage proximate outside bottom surface 216, thereby preventing bearing elements 218 from passing through the passages, but sufficiently large to allow a portion of each bearing element 218 to protrude beyond the plane of outside bottom surface 216. Plenum 212 is provided with a pressurized gas, such as clean, dry air, through at least one inlet port 222 which seats the bearing in each passage against the narrowed portion 220 of the passage (FIG. 14). When the bearing is seated against narrowed portions 220, a portion of the bearings extend beyond housing bottom surface 216. Each passage 214 may further comprise a means for preventing each bearing element from falling out the back end of each passage into plenum 212 as well. For example, each passage could be peened over to restrict the passage entrance once the bearing has been inserted, or be fitted with a collar that restricts the bearing from exiting the passage. Alternatively, plenum 212 may be fitted with a porous material, such as a foam pad (not shown) that allows pressurized gas to enter the passages from plenum 212, but that prevents each bearing from leaving the passages.

Housing 210 further defines a passage or channel 224 extending from housing top surface 226 to housing bottom surface 216. Slot 228 extends between side surface 230 of housing 210 to passage 224. Collet 42 is adapted to fit within passage 224 and slot 228. Collet 42 is attached to positioning system 152, thereby allowing a position of housing 210 to be adjusted via bearing block 106 and adjustment screw 122. Positional adjustment of housing 210 relative to substrate assembly 46 is accomplished as previously described.

Unlike embodiments where a spring is used to apply a restoring (preload) force, preloading of bearings 218 is provided by the pressurized gas within plenum 212 and the individual bearing passages 214, and may be maintained substantially constant. Moreover, in some embodiments, the position of apparatus 10 above substrate assembly 46 may not be rigidly constrained to positioning system 152 in a “Z” direction (perpendicular to a top surface of substrate assembly 46), so that the force applied to the substrate assembly is substantially the force derived from the weight of apparatus 10. This may be visualized as such for the case of a single bearing 218: For a given gas pressure supplied to housing 210, a given force (derived from the weight of apparatus 10) is required against bearing 218 to depress bearing 218 within passage 214. If the gas pressure is greater than the weight of apparatus 10, the ball bearing will not be depressed into passage 214. The ball bearing will be held (seated) against narrowed portion 220, which may cause the bearing to drag on the surface of substrate 54 and potentially damaging the substrate if housing 210, and bearing 218, is translated over a surface of substrate assembly 46. If the force exerted on the bearing by the gas pressure is slightly less than the force exerted by the weight of apparatus 10, the bearing will be depressed into passage 214, allowing an airflow around the bearing and out of passage 214. This airflow provides a lubricating environment for the bearing, allowing it to roll smoothly on a surface of the substrate assembly (e.g. on a surface of substrate 54). If, however, the force exerted on the bearing by the gas pressure is substantially less than the force exerted by the weight of apparatus 10, the bearing will be depressed into passage 214 to the extent that bottom surface 216 of housing 210 will contact substrate 54, potentially damaging the substrate. In this instance, “substantially less” is the maximum force that allows housing 210 to contact a surface of the substrate assembly. It should be evident, then, that the pressure of the gas should be sufficiently balanced with the expected load applied to the individual bearings, i.e. according to the weight of apparatus 10, so that each bearing 218 is depressed into a passage 214 sufficiently to allow a lubricating airflow, and not allow housing 210 to contact substrate assembly 46. The force applied against assembly 46 can be adjusted by increasing the weight of the apparatus. An unconstrained apparatus 10 employing housing 210 can be approximated, for example, by coupling housing 210 to an upper support framework (not shown) so that housing 210 is substantially free to move in a vertical “Z” direction, the support framework being rigidly attached to positioning system 152. For example, housing 210 may be coupled to an upper support frame by providing housing 210 with vertical shafts what ride within openings in the support framework (or vice versa), or housing 210 may be coupled to a support framework/bracket via a wave spring, weak leaf spring or other resilient member that does not significantly impede vertical movement of the housing.

It should be emphasized that the above-described embodiments of the present invention, particularly any “preferred” embodiments, are merely possible examples of implementations, merely set forth for a clear understanding of the principles of the invention. Many variations and modifications may be made to the above-described embodiments of the invention without departing substantially from the spirit and principles of the invention. All such modifications and variations are intended to be included herein within the scope of this disclosure and the present invention and protected by the following claims.

What is claimed is:

1. A method for sealing a glass package comprising:
providing an assembly comprising first and second glass substrates and a sealing material disposed between the first and second substrates;
contacting the assembly with at least one bearing element to exert a force against the first or second substrate;
irradiating the sealing material with a beam of radiation emitted by a radiation source; and
translating the bearing element and the radiation source during the irradiating, thereby forming a hermetic seal between the first and second substrates.

2. The method according to claim 1 wherein the sealing material is a frit and the irradiating heats and softens the frit.

3. The method according to claim 1 wherein the assembly further comprises an organic light emitting diode device disposed between the substrates.

4. The method according to claim 1 wherein the at least one bearing element comprises a rolling bearing element.

5. The method according to claim 1 wherein the at least one bearing element comprises a sliding bearing element

6. The method according to claim 1 wherein the contacting comprises contacting the second substrate with a plurality of bearing elements.

7. The method according to claim 1 wherein the plurality of bearing elements are disposed about the beam of radiation.

8. The method according to claim 1 wherein the beam of radiation is a laser beam.

9. The method according to claim 1 wherein a restoring force is applied to the bearing element.

10. The method according to claim 6 wherein the restoring force is applied by a spring.

11. The method according to claim 6 wherein the restoring force is applied by a gas.

12. The method according to claim 1 wherein a force applied to the second substrate by each of the at least one bearing elements is less than about 3 lbs.

13. A method for sealing a glass package comprising:
providing an assembly comprising first and second glass substrates and a frit disposed between the first and second substrates;
contacting the assembly with a plurality of bearing elements to exert a force against the assembly;
irradiating the frit with a laser beam to heat and soften the frit; and
translating the plurality of bearing elements relative to the frit and in unison with the laser beam, thereby forming a hermetic seal between the first and second substrates.

14. The method according to claim 13 wherein the plurality of bearing elements are rolling bearing elements.

15. The method according to claim 13 wherein the bearing elements are sliding bearing elements.

16. The method according to claim 13 wherein the bearing elements are biased by a spring.

17. The method according to claim 13 wherein the bearing elements are biased by a gas.

18. An apparatus for sealing a glass assembly comprising:
a housing defining at least one bore;
a bearing element disposed within the at least one bore and moveable relative to the bore for applying a force to an assembly comprising glass substrates and a sealing material;
means for applying a restoring force to the bearing element;
means for translating the housing relative to the assembly; and
a radiation source adapted to emit a beam of radiation that moves in unison with the housing to irradiate the sealing material.

19. The apparatus according to claim 13 wherein the bearing element is a ball bearing.

20. The apparatus according to claim 13 wherein the restoring force is applied by a spring.

21. The apparatus according to claim 13 wherein the restoring force is applied by a gas.

22. The apparatus according to claim 13 wherein the housing comprises a plurality of bores, each bore of the plurality of bores including a bearing element.
